(19) United States
(12) Patent Application Publication
(10) Pub. No.: US 2025/0030714 A1
(43) Pub. Date: Jan. 23, 2025

(54) KERNEL SPACE FEATURE GENERATION FOR USER SPACE MACHINE LEARNING-BASED MALICIOUS NETWORK TRAFFIC DETECTION

(71) Applicant: Palo Alto Networks, Inc., Santa Clara, CA (US)

(72) Inventors: Lei Xu, Palo Alto, CA (US); Yang Ji, San Jose, CA (US); Yu Fu, Los Gatos, CA (US)

(21) Appl. No.: 18/355,486

(22) Filed: Jul. 20, 2023

(51) Int. Cl. H04L 9/40

(52) U.S. Cl. CPC H04L 63/1425; H04L 63/162

(57) ABSTRACT

An in-kernel virtual machine (“VM”) instantiated in the kernel space of a physical or virtual machine (“machine”) attaches code hooks at a network interface of the machine. The code hooks redirect network traffic from the network interface to a module that generates feature values at the kernel space from protocol data units of network traffic received by the network interface. The machine passes the feature values from kernel space to user space via zero-copy shared memory and a machine learning model in the user space obtains network traffic verdicts as outputs from inputting the feature values. The machine passes the verdicts from user space to kernel space via the zero-copy shared memory and the in-kernel VM performs corrective action based on malicious verdicts.

### BACKGROUND

The disclosure generally relates to transmission of digital information (e.g., CPC subclass H04L) and to wireless communication networks (e.g., CPC subclass H04W).

Berkeley Packet Filter (BPF) is a codebase that enables execution in kernel space of an operating system of processes, code hooks, etc. generated at user space. BPF can attach or bind code hooks to a network interface at the kernel space of the operating system to receive data link layer network traffic. eBPF is an extension built on top of BPF that enables access to additional kernel functions and system memory at the kernel space of the operating system. BPF and eBPF operate by instantiating a virtual machine (“VM”) in the kernel space of the operating system and loading/attaching code from the user space to the kernel space with the in-kernel VM. Code hooks attached by the in-kernel VM are triggered by events such as receiving network traffic at the network interface.

### BRIEF DESCRIPTION OF THE DRAWINGS

Embodiments of the disclosure may be better understood by referencing the accompanying drawings.

FIG. 1 is a schematic diagram of an example system for generating feature value inputs to a user space machine learning model at the kernel space of a physical or virtual machine.

FIG. 2 is a schematic diagram of example feature values and rules generated/applied by a protocol data unit (PDU) processing module in a kernel space of a physical or virtual machine.

FIG. 3 is a flowchart of example operations for detecting malicious network traffic with kernel space generation of network traffic feature values comprising inputs to a machine learning model at a user space.

FIG. 4 is a flowchart of example operations for training a machine learning model for malicious network traffic detection on feature values generated in the kernel space of a physical or virtual machine.

FIG. 5 depicts an example computer system with an in-kernel VM that attaches code hooks at a network interface and a user space machine learning model.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

The term “passing” is used herein in reference to data being transferred from a user space to a kernel space and vice versa of a physical or virtual machine. Passing data need not include copying data, for instance when implemented with zero-copy shared memory between the kernel space and the user space. Passing data can occur across a network stack implementation that comprises data link layer network traffic at the kernel space and application layer network traffic at the user space of the physical or virtual machine.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Overview

Detection of malicious attacks using machine learning models on feature values extracted by deep packet inspection typically involves passing protocol data units (PDUs) of network traffic received by a network interface at the data link layer to the machine learning models at the application layer of a network stack implementation. The machine learning models take feature values generated from the PDUs and output malicious or benign verdicts. The verdicts are then passed to the data link layer and corrective action is performed based on malicious verdicts. For lightweight machine learning models that efficiently process inputs to generate verdicts, the bulk latency/operational cost for malicious traffic detection comprises passing PDUs between the data link layer to the application layer of the network stack. Network interfaces that receive network traffic typically interface with a kernel space (e.g., a driver) of an operating system for a physical or virtual machine analyzing the network traffic (e.g., a firewall), whereas the application layer operations performed by the machine learning model are at a user space of the physical or virtual machine.

The present disclosure implements eBPF to attach code hooks to a network interface at the kernel space of a physical or virtual machine monitoring network traffic to redirect network traffic to a virtual machine running in the kernel space. The virtual machine generates feature value inputs to machine learning models directly from PDUs at the data link layer in the kernel space. The feature values (as opposed to the entire PDUs of network traffic) are passed to the application layer/user space and are input to the machine learning models to obtain malicious or benign verdicts as outputs. The malicious or benign verdicts are then passed to the data link layer for potential corrective action. The feature values and verdicts are passed in zero-copy shared memory to reduce latency. The virtual machine additionally has the functionality to, during or prior to generation of feature values, determine that PDUs of malicious traffic are malicious and throttle/block network traffic or perform other corrective action prior to passing any data up the network stack in response. The implementation of code hooks and the virtual machine at the data link layer or link layer reduces latency of malicious attack detection and thus provides robust protection against high-volume cyberattacks such as distributed denial-of-service (DDOS) attacks.

### Example Illustrations

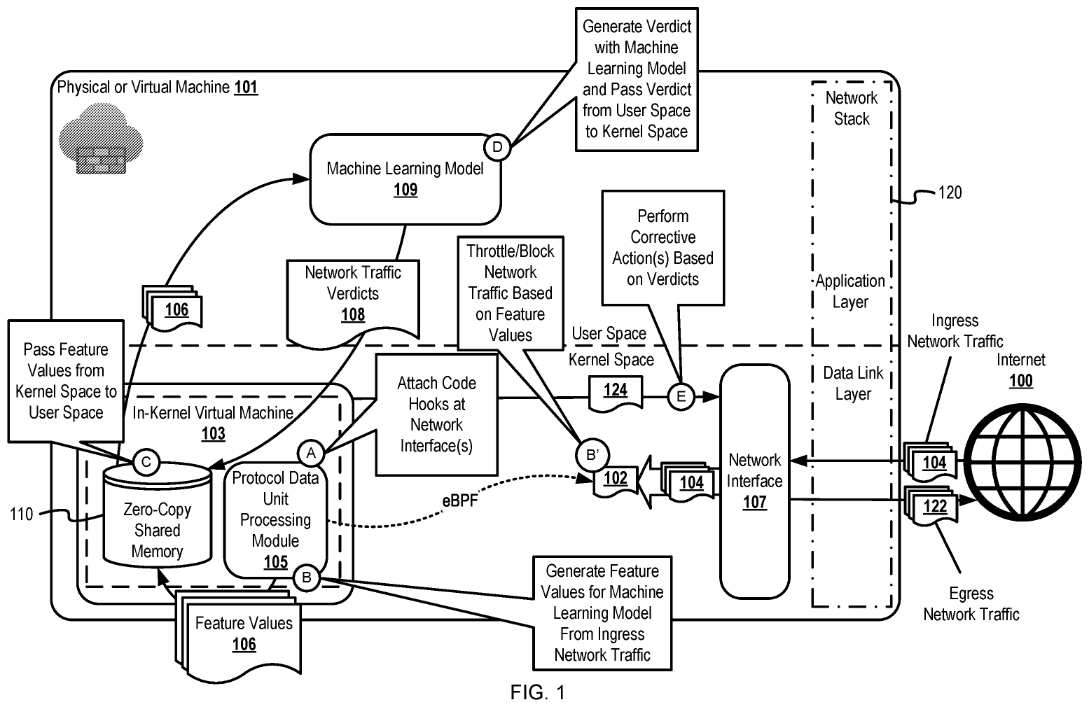

FIG. 1 is a schematic diagram of an example system for generating feature value inputs to a user space machine learning model at the kernel space of a physical or virtual machine. A physical or virtual machine (“machine”) 101 (e.g., a firewall) for deep packet inspection and filtering processes ingress network traffic 104 from the Internet 100 at a data link layer of a network stack implementation 120 by the machine 101. A network interface 107 receives the ingress network traffic 104. An in-kernel VM 103 running on the machine 101 attaches code hooks 102 at the network interface 107 to receive PDUs for processing. The in-kernel VM 103 comprises a VM running in the kernel space of the machine 101 that implements user space functionality enabled by eBPF. The code hooks 102 attached by the in-kernel VM 103 redirect the ingress network traffic 104 from the network interface to a PDU processing module 105. The PDU processing module 105 generates feature values 106 that the machine 101 passes up the network stack implementation 120 to the application layer/user space of the machine 101 via zero-copy shared memory 110. A machine learning model 109 running at the application layer/user space of the machine 101 receives the feature values 106 as inputs and outputs network traffic verdicts 108 that the machine 101 passes to the data link layer via zero-copy shared memory 110. The network interface 107 and/or other cybersecurity component of the machine 101 performs corrective action based on the network traffic verdicts 108.

FIG. 1 is annotated with a series of letters A, B, B′, and C-E. Each stage represents one or more operations. Stage B′ indicates an optional stage that, when it occurs, skips the remaining operations at stages C-E. Although these stages are ordered for this example, the stages illustrate one example to aid in understanding this disclosure and should not be used to limit the claims. Subject matter falling within the scope of the claims can vary from what is illustrated. For instance, the operations at stages B and B′ can occur in parallel or the operations at stage B′ can occur prior to the operations at stage B.

At stage A, the PDU processing module 105 at the in-kernel VM 103 attaches code hooks 102 to the network interface 107 to receive and redirect PDUs of network traffic to the PDU processing module 105 at the data link layer of the network stack implementation 120. The PDU processing module 105 comprises software components generated at the user space of the machine 101 and running in the kernel space with eBPF. The code hooks 102 are configured to execute in response to an event—in this instance, PDU receipt by the network interface 107. The machine 101 constructs the PDU processing module 105 including the code hooks 102 in its user space and implements the functionality of eBPF to attach the PDU processing module 105 and code hooks 102 to its kernel space as sandboxed programs by instantiating the in-kernel VM 103. Once attached, the PDU processing module 105 and stores data generated from processing in ingress network traffic 104 in data structures called eBPF maps.

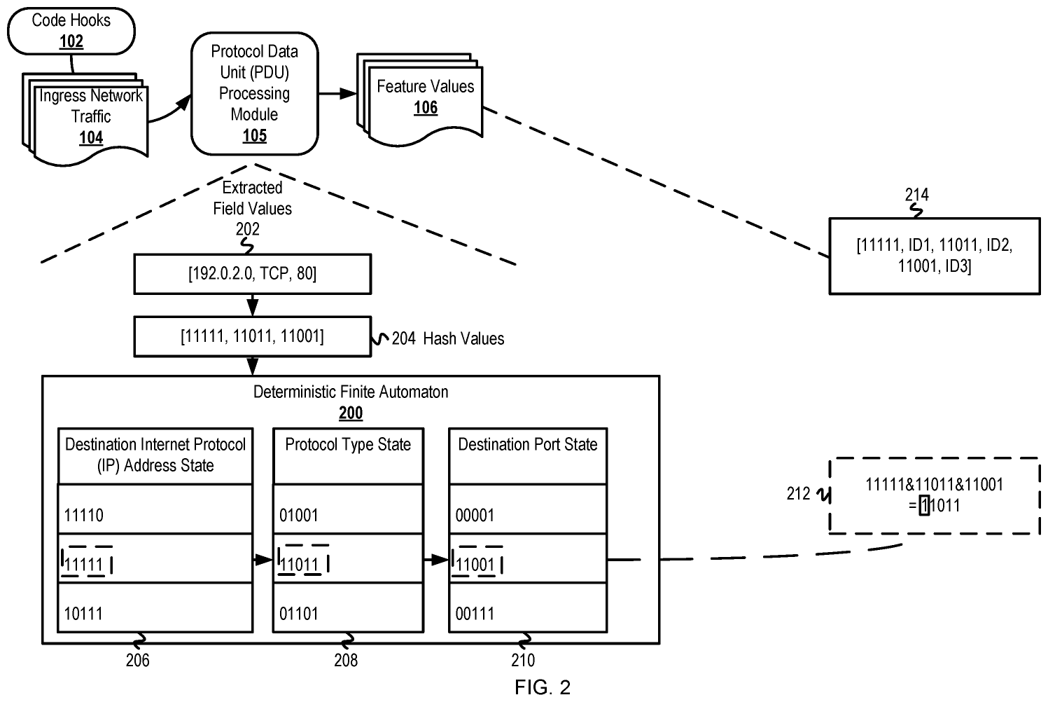

At stage B, the PDU processing module 105 generates feature values 106 as inputs to the machine learning model 109 from the ingress network traffic 104. The feature values 106 can vary with respect to data structures, fields extracted from the ingress network traffic 104 for feature value generation, and the like depending on the type of machine learning model 109. As an illustrative example, the machine learning model 109 can comprise a string-matching model, and the feature values 106 can comprise strings (e.g., signatures) generated based on values of fields in PDUs of the ingress network traffic 104. An implementation that generates representations of PDUs of the ingress network traffic 104 as deterministic finite automata based on values of fields extracted from the PDUs, target values of fields, and state transitions between fields is depicted in greater detail in FIG. 2. Other implementations can generate, for instance, signatures of network traffic and the machine learning model 109 can match the signatures of network traffic against a database of signatures corresponding to known malicious attacks.

The machine learning model 109 can alternatively comprise a gradient boosting model, a random forest model, a neural network model, a logistic regression model, or any machine learning classifier for detecting malicious network traffic. The feature values 106 can comprise feature values stored in various eBPF map data structures such as hash maps, arrays, tries, bloom filters, etc. Feature preprocessing varies by type of the machine learning model 109. For instance, for a neural network the feature values 106 can comprise values of fields extracted from PDUs of the ingress network traffic 104 preprocessed with natural language processing by the PDU processing module 105 and stored in an array eBPF map. Each preprocessed values of a field can alternatively be stored as a hash map or bloom filter eBPF map for increased efficiency of storage. The feature values 106 can additionally comprise data for flow of the ingress network traffic 104. The PDU processing module 105 can track statistics of network traffic flow such as PDU length distributions for both the ingress network traffic 104 and egress network traffic 122 from the machine 101, average intervals between PDUs, PDU volume, etc. over time windows. Accordingly, the feature values 106 can vary with respect to scope, with some feature values of the feature values 106 corresponding to individual PDUs or protocol data units and others corresponding to multiple PDUs or protocol data units.

In some embodiments, for instance when the machine learning model 109 comprises a classifier such as a gradient boosting model, a neural network, a random forest classifier, etc., the feature values 106 comprise vectors with indicators of whether corresponding malicious strings are present in the ingress network traffic 104. For instance, the PDU module 105 can maintain a database of strings known to correspond to malicious network traffic such as “malware.com”. Each entry of a vector generated for the feature values 106 can correspond to a string in the database, with a 1 entry indicating the presence of the string in the ingress network traffic 104 and a 0 entry indicating that the string is not in the ingress network traffic 104. Any of the foregoing examples of feature values can be included in combination in the feature values 106.

At stage B′, the PDU processing module 105 determines, during feature generation, that the ingress network traffic 104 is malicious. For instance, the PDU processing module 105 can comprise a set of rules that determine a PDU is malicious when satisfied, and when any of the set of rules is satisfied the PDU processing module 105 can communicate instructions to the network interface 107 to throttle network traffic at the machine 101 and/or at various ports at the machine 101 (e.g., ports corresponding to protocols of the malicious traffic). These rules can comprise rules for combinations of values for fields extracted from PDUs including destination ports, destination IP addresses, protocol types, HyperText Transfer Protocol (HTTP) cookies, Uniform Resource Locators (URLs), hostnames, Server Name Indications (SNIs), Domain Name System (DNS) records, etc. For instance, the PDU processing module 105 can maintain a blacklist of URLs, destination IP addresses, etc. that are known to correspond to malicious actors. Alternatively, the PDU processing module 105 can compute hash maps of various fields, perform bitwise operations on the hash maps, and determine whether the generated bit strings match rules, e.g., values for certain bits.

The PDU processing module 105 can additionally analyze network traffic flow statistics when determining whether to throttle/block network traffic during feature generation. Analysis of network traffic flow allows for rapid response to DDOS attacks at the data link layer of the network stack implementation 120 by immediately identifying unusually high PDU frequency. The code hooks 102 can additionally maintain network traffic flow statistics for various times of day such as each hour and can identify anomalous behavior such as increased network traffic flow during off-peak hours. Based on the identified anomalous behavior, the PDU processing module 105 can communicate instructions to the network interface 107 to throttle/block network traffic or can flag the ingress network traffic 104 for potentially malicious behavior to a separate cybersecurity system (e.g., a separate module of the machine 101). When, at stage B′, the PDU processing module 105 determines to throttle or block ingress network traffic 104, the remaining operations at stages C-E can be omitted.

At stage C, the in-kernel VM 103 passes the feature values 106 from the kernel space to the user space of the machine 101 via zero-copy shared memory 110. While depicted in the kernel space of the machine 101 for exposition, the zero-copy shared memory 110 employs shared memory across the user space and the kernel space of the machine 101 to circumvent central processing unit (CPU) memory copying operations. The zero-copy shared memory 110 is implemented with a functionality such that programs (including sandbox programs implemented using eBPF) in both the user space and the kernel space have access to modify, read, and write data. Consequently, the zero-copy shared memory 110 reduces overall memory storage as well as latency in PDU processing by the machine 101.

At stage D, the machine learning model 109 receives as inputs the feature values 106 from the zero-copy shared memory 110 to generate network traffic verdicts 108. The machine 101 then passes the verdicts from the user space to the kernel space in zero-copy shared memory 110. For instance, the machine 101 can pass data from the user space to the kernel space and vice versa with sockets of AF_XDP built on top of eBPF and/or eBPF maps depending on complexity of the data structure for the feature values 106 (e.g., AF_XDP for socket data types or eBPF maps for hybrid data types such as hashes, arrays, bloom filters, etc.). The in-kernel VM 103 or other cybersecurity component of the machine 101 receives the network traffic verdicts 108. In other embodiments, the machine 101 performs at least a subset of corrective actions based on the network traffic verdicts 108 at the application layer/user space. For instance, the machine learning model 109 can communicate any malicious verdicts in the network traffic verdicts 108 in an alert at a graphical user interface (GUI) (not depicted) for one or more users or organizations monitored by the machine 101. The machine learning model 109 can communicate with other components of the machine 101 that assess risk of endpoint devices or other network entities for a network corresponding to the ingress network traffic 104.

Training of the machine learning model 109 varies by type of machine learning model and format of inputs. In some instances, the machine learning model 109 is trained on feature values and corresponding malicious/benign labels. The training data comprising feature values and their labels is split into training/testing/validation data and training occurs until termination criteria occur, e.g., that training/testing/validation error are sufficiently low, that a threshold number of training epochs has occurred, that internal parameters of the machine learning model 109 converge across iterations, etc. Alternatively, for instance when the machine learning model 109 is a string-matching model and the feature values are signatures, training comprises populating a database of signatures or other network traffic representations and assign them labels indicating whether each signature or representation is malicious or benign.

At stage E, the in-kernel VM 103, based on one or more malicious verdicts in the network traffic verdicts 108, communicates instructions 124 to the network interface 107 that indicate a corrective action(s) to perform. For instance, the instructions 124 can indicate to throttle or block ingress network traffic 104 or egress network traffic 122 for specified ports, IP addresses, etc. Although depicted as interfacing with the Internet 100, the ingress network traffic 104 and egress network traffic 122 can comprise traffic from private networks, e.g., branch locations of an organization monitored by the machine 101.

FIG. 2 is a schematic diagram of example feature values and rules generated/applied by a PDU processing module in a kernel space of a firewall. FIG. 2 references the ingress network traffic 104, the code hooks 102, and the feature values 106 generated by the PDU processing module 105 in FIG. 1. The code hooks 102 are attached to receive and redirect PDUs from the network interface 107 comprising the ingress network traffic 104 with eBPF. The PDU processing module 105 receives the ingress network traffic 104 from the code hooks and extracts values such as example extracted field values 202 from PDUs of the ingress network traffic 104. The example extracted field values 202 comprise a destination IP address field with value “192.0.2.0”, an example protocol type field with value “TCP”, and an example destination port field with value “80”. The PDU processing module 105 applies hash maps to the example extracted field values 202 to generate example hash values 204 comprising the array [11111, 11011, 11001].

The PDU processing module 105 uses the hash values 204 to generate a representation of the ingress network traffic 104 as a path in a deterministic finite automaton (“DFA”) 200 such as example representation 214. The example representation 214 comprises an array [11111, ID1, 11011, ID2, 11001, ID3], wherein “ID1”, “ID2”, and “ID3” are identifiers of a destination IP address state 206, a protocol type state 208, and a destination port state 210 of the DFA 200, respectively. To generate the example representation 214, the PDU processing module 105 searches for the first hashed value “11111” in the state 206 for the corresponding extracted field (i.e., destination IP address), if present. Based on identifying the value “11111” in the state 206, the PDU processing module 105 progresses through states 208, 210 based on state transitions in the DFA 200 by matching values in the hash values 204 with values stored at the corresponding states 208, 210. If the values in the hash values 204 are not present in corresponding states of the DFA 200, the PDU processing module 105 terminates operations and output the path through the DFA 200 identified for previous states (if any).

During generation of the example representation 214, the PDU processing module 105 also applies rules to the hash values 204 based on their corresponding fields to determine whether to perform corrective action. Example rule 212 comprises a bitwise AND operation on hash values for the destination IP address, protocol type, and destination port fields. Applying the example rule 212 determines whether the first bit after the bitwise AND operations is a 1 bit and, based on the first bit being a 1 bit, triggers corrective action (e.g., by throttling or blocking the ingress network traffic 104). Subsequent to triggering corrective action, the PDU processing module 105 terminates existing processes for generating the feature values 106. Generation of the feature values 106 such as example representation 214 corresponds to operations at stage B in FIG. 1, and triggering corrective action based on the example rule 212 corresponds to operations at stage B′ in FIG. 1.

Subsequent to generating the example representation 214, a string-matching model running in user space receives the example representation 214 via zero-copy shared memory and matches the example representation 214 against a database of strings to determine any matches with strings corresponding to known malicious attacks. The string-matching model can implement any exact or approximate string-matching algorithm, e.g., the Aho-Corasick algorithm. Based on identifying a matching string, the string-matching model communicates a malicious verdict for the ingress network traffic 104 from user space to kernel space via zero-copy shared memory. The malicious verdict can comprise metadata associated with the identified matching string such as a common vulnerability and exposure (CVE) identifier and a severity level.

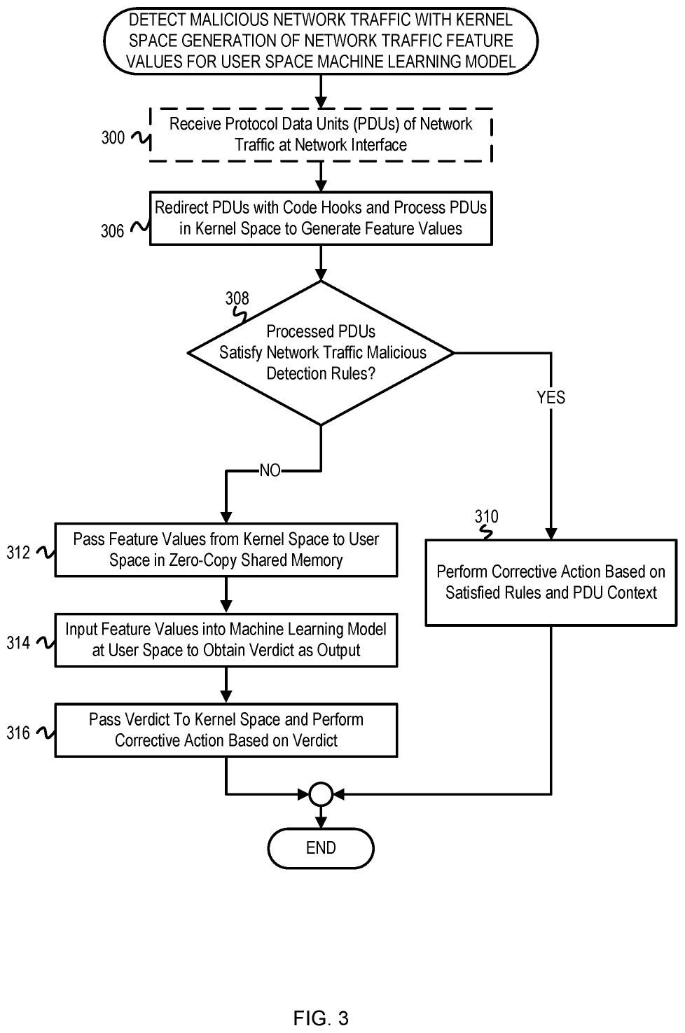

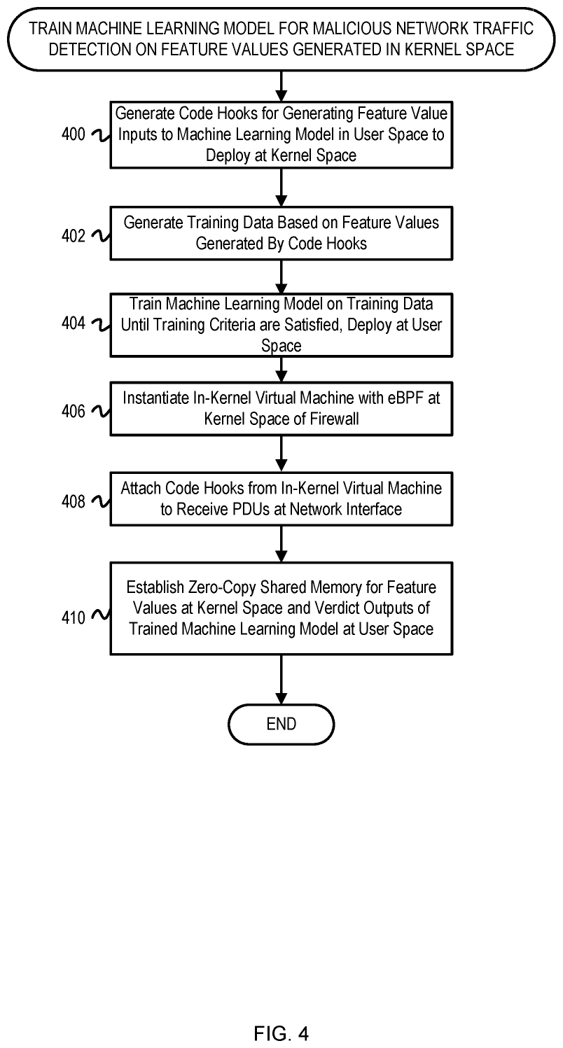

FIGS. 3 and 4 are flowcharts of example operations for training and deploying a system that generates feature values of network traffic at a kernel space of a physical or virtual machine (“machine”) and inputs generated feature values into a trained machine learning model at a user space of the machine to obtain network traffic verdicts. The example operations are described with reference to a machine learning model, a machine, an in-kernel VM, a PDU processing module (“module”), and code hooks for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for detecting malicious network traffic with kernel space generation of network traffic feature values comprising inputs to a machine learning model in a user space. The kernel space and the user space described in FIG. 3 are in reference to a machine but can also be those of another type of cybersecurity component monitoring network traffic for malicious behavior.

At block 300, the machine receives protocol data units (PDUs) of network traffic at a network interface. The machine can be deployed in the cloud to monitor internal or external network traffic for an organization or can be deployed inline at an endpoint device. Block 300 is depicted with a dashed line to indicate that receiving PDUs of network traffic at the machine is ongoing during the remaining operations depicted in FIG. 3 until an external trigger occurs (e.g., a network administrator deactivating the machine).

At block 306, the machine redirects the PDUs with code hooks and processes PDUs with the module in kernel space to generate feature values. The feature values comprise inputs to a machine learning model implemented in the user space of the machine. The code hook(s) are generated and attached to outputs of the network interface by an in-kernel VM with eBPF and attached such that they are triggered based on one or more events that occur as part of the network interface receiving PDUs.

The module receives and processes network traffic redirected by the code hook(s) to generate the feature values. The feature values vary with respect to length, data structure type, etc. depending on the type and architecture of the machine learning model. The machine stores the feature values in eBPF maps such as hash maps, bloom filters, arrays, etc. Example feature values comprise signatures, natural language processing feature values (e.g., by applying word2vec to values of fields extracted from PDUs), DFA representations, network traffic flow statistics, etc. Feature values such as network traffic flow statistics can be computed based on multiple PDUs, whereas other feature values such as signatures, DFA representations, etc. can be generated for each PDU. In some instances, the feature values comprise vectors with 0/1 entries, each entry indicating whether a corresponding malicious string is present in the PDUs of network traffic.

At block 308, the machine determines, at the kernel space, whether the processed PDUs satisfy network traffic malicious detection rules (“malicious detection rules”). The malicious detection rules can be rules applied to the feature values themselves or other values such as hashes of values extracted from fields of PDUs. The malicious detection rules can comprise bitwise rules such as determining whether certain bit values are 1 or 0 subsequent to bitwise AND/OR/XOR operations on bit strings generated based on PDUs. Other rules can comprise rules for network traffic flow statistics across PDUs such as threshold values for PDU frequency, and the rules for network traffic flow can vary by day and time of day (e.g., lower thresholds for off-peak hours). Although depicted as subsequent to block 306, the operations at block 308 can occur in parallel with to or prior to feature value generation. For instance, the machine can first apply the malicious detection rules and, based on determining that one or more rules are satisfied, omit operations for generating feature values. If one or more of the malicious detection rules are satisfied, operational flow proceeds to block 310. Otherwise, operational flow proceeds to block 312.

At block 310, the machine performs corrective action based on the satisfied rules and PDU context. Each malicious detection rule can have associated severity levels that inform corrective action. For instance, higher severity rules can substantially immediately trigger blocking network traffic at ports corresponding to the PDUs at the machine, whereas lower severity rules can trigger a user warning in a GUI at an endpoint device receiving the PDUs via the machine. PDU context additionally informs corrective action. For instance, PDUs communicated to or from a server storing sensitive data can trigger higher severity corrective action than PDUs to or from communicated from the Internet. Blocking network traffic based on rules applied at the kernel space improves response time for high volume attacks such as DDOS attacks by blocking unauthorized traffic as early as possible.

At block 312, the machine passes the feature values from kernel space to user space in zero-copy shared memory. Passing the feature values in zero-copy shared memory reduces overage storage from duplicate storage of the feature values in kernel space and user space and reduces latency in generating verdicts for network traffic by skipping CPU operations for memory copying. The feature values can be copied as eBPF maps, e.g., with eBPF syscall commands and/or as socket data types with AF_XDP built on top of eBPF.

At block 314, the machine inputs the feature values into a machine learning model at the user space to obtain a verdict as output. The verdict indicates whether the PDUs correspond to malicious or benign network traffic and can further comprise metadata such as CVE identifiers, severity levels, etc. The machine learning model can comprise any classifier, e.g., a random forest model, a neural network, a gradient boosting model, a string-matching model, a support vector machine, a logistic regression model, etc.

At block 316, the machine passes the verdict output by the machine learning model to the kernel space and performs corrective action based on the verdict. For instance, the machine learning model or a separate component at the user space or kernel space can determine corrective action based on a malicious verdict that accounts for context of the PDUs and communicate indications of the corrective action to a network interface of the machine to block or throttle network traffic and to a user interface to display an alert indicating the malicious verdict and metadata such as destination ports/IP addresses, severity, etc. The machine can comprise additional cybersecurity components that assess network traffic, processes running at endpoints receiving the network traffic, etc. to identify potentially malicious behavior based on the malicious verdict.

FIG. 4 is a flowchart of example operations for training a machine learning model for malicious network traffic detection on feature values generated in the kernel space of a machine. The machine learning model is executed in the user space of the machine and is configured to receive feature value inputs that the machine passes from the kernel space to the user space (e.g., via zero-copy shared memory and stored as eBPF maps). The user space can be conceptualized as occurring at the application layer of a network stack implementation by the machine, and the kernel space can be conceptualized as occurring at a data link layer of the network stack implementation. A domain-level expert can design the type and architecture of the machine learning model according to the structure of feature values passed from kernel space to user space. The feature values are engineered based on fields from PDUs of network traffic known to indicate malicious network traffic and can vary by protocol type. Accordingly, the machine learning model can be configured to receive different input formats and/or sizes for different protocol types.

At block 400, the machine generates the module for generating feature value inputs to the machine learning model at the user space to deploy at the kernel space. For instance, the machine can generate the module at the user space with eBPF. Generating the module at the user space allows the machine to add the functionality of generating feature values not otherwise available at the kernel space. The feature values can comprise network traffic signatures, natural language processing feature values, string representations, etc. that are able to be stored in data structures such as eBPF maps in kernel space memory of the machine and are passed from the kernel space to the user space of the machine in zero-copy shared memory. The module can have additional functionality to apply malicious detection rules to PDUs of network traffic at the kernel space of the machine. For instance, the rules can comprise whether network traffic flow statistics exceed thresholds (e.g., the number of PDUs received in the past minute is above a threshold number of PDUs). Alternatively, the rules can comprise rules applied to hashes of values of fields extracted from the PDUs, for instance, rules that determine whether entries of bitstrings are 0 or 1, wherein the bitstrings are generated from bitwise AND/OR/XOR operations applied to the hashes.

At block 402, the machine generates training data based on formats of feature values generated by the module. For instance, the machine can access a database of PDUs corresponding to known malicious and known benign network traffic and can generate feature values from PDUs of the database with the algorithm used by the module. Each set of feature values is associated with a label indicating whether the corresponding PDUs are for known malicious or known benign network traffic. Depending on how the machine learning model is trained, the machine can split the training data into training/testing/validation data.

At block 404, the machine trains the machine learning model on the training data until training criteria are satisfied and deploys the trained machine learning model at the user space. For instance, for a neural network machine learning model that training criteria can comprise that a threshold number of epochs have occurred, that training/testing/validation error is sufficiently low, that internal parameters of the neural network converge across training iterations, etc. Training of certain types of machine learning model such as string-matching models that match network traffic signatures against a database of malicious network traffic signatures comprises generating the malicious traffic signatures from PDUs of known malicious traffic to populate the database.

At block 406, the machine instantiates the in-kernel VM with eBPF at the kernel space of the machine. Alternatively, for a Linux® operating system, the machine can implement the Kernel-based Virtual Machine virtualization module that allows the Linux kernel to function as a hypervisor for one or more VMs. The in-kernel VM has functionality to attach code hooks generated in the user space of the machine at various drivers/interfaces of the machine. The in-kernel VM additionally manages zero-copy shared memory between the user space and the kernel space of the machine. For eBPF implementations, the in-kernel VM comprises a register-based VM with a custom 64-bit reduced instruction set computer architecture that is capable of running just-in-time, native-compiled “BPF programs” inside the Linux® kernel with access to a subset of kernel functions and memory.

At block 408, the in-kernel VM attaches the code hooks generated in the user space to receive PDUs at the network interface. The in-kernel VM configures the code hooks to execute in response events at to the network interface indicating receiving PDUs. The code hooks redirect network traffic from the network interface to the module. Although triggered by events for the network interface receiving PDUs, the module can track data for feature values across multiple PDUs, for instance network traffic flow statistics. Accordingly, the module can track times when the network interface receives PDUs to generate network traffic flow statistics for different days and times of day.

At block 410, the in-kernel VM establishes zero-copy shared memory for feature values at the kernel space and verdict outputs of the trained machine learning model at the user space of the machine. The zero-copy shared memory allows for passing the feature values from the kernel space to the user space and passing the verdict outputs from the user space to the kernel space without duplicating the feature values and the verdicts and reducing CPU operations at the machine.

### Variations

The present disclosure refers to a machine for illustrative purposes. Methods for feature value generation at a kernel space to input to a machine learning model at a user space can occur at the kernel space and the user space of any physical or virtual cybersecurity component. The cybersecurity component can be deployed natively at an endpoint device, in the cloud, at a hybrid cloud/native deployment, etc.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 306 and 308 can be performed in parallel or concurrently. With respect to FIG. 4, generating training data at block 401 is not necessary for certain types of machine learning models such as signature matching models. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

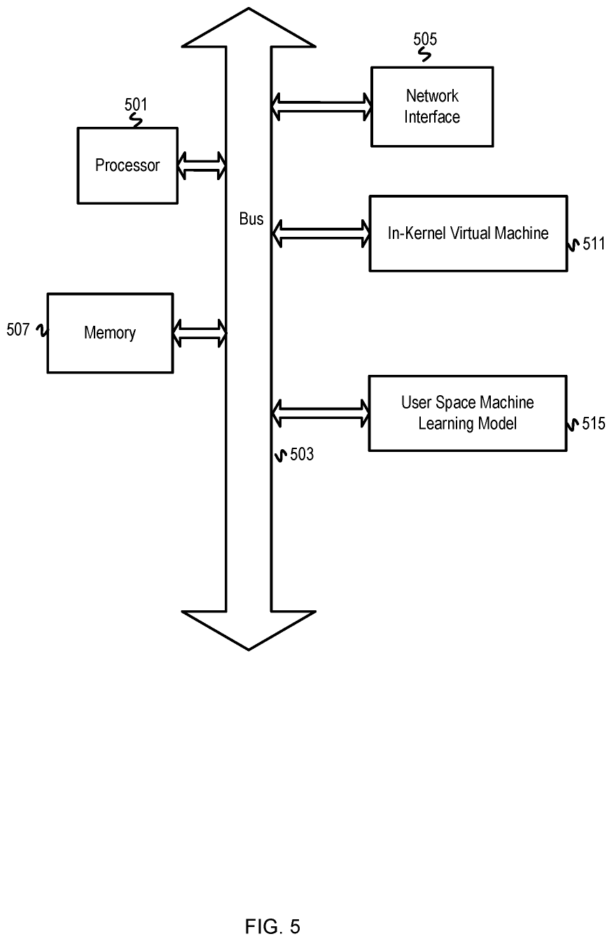

FIG. 5 depicts an example computer system with an in-kernel VM that attaches code hooks at a network interface and a user space machine learning model. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system also includes an in-kernel VM 511 and a user space machine learning model (“ML model”) 515. The in-kernel VM 511 is instantiated at a kernel space of the example computer system and attaches code hooks to the network interface 505. The code hooks redirect PDUs from the network interface 505 to code at the in-kernel VM 511 for generating feature values in kernel space and passing the feature values to user space. The code hooks are configured to trigger in response to events indicating receiving PDUs at the network interface 505. The in-kernel VM 511 passes feature values generated the kernel space to the ML model 515 at the user space via zero-copy shared memory. The ML model 515 obtains verdicts for network traffic corresponding to the PDUs as outputs from inputting the feature values and the example computer system passes the verdicts from the user space to the kernel space via the zero-copy shared memory. The in-kernel VM 511 communicates instructions to perform corrective action based on the verdicts passed to the kernel space. The in-kernel VM 511 additionally has functionality to identify malicious PDUs and perform corrective action prior to passing feature values from kernel space to user space. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

1. A method comprising:
generating, at a kernel space, a one or more feature values comprising inputs to a machine learning model from network traffic at the data link layer of a network stack;
passing the one or more feature values from the kernel space to a user space, wherein the user space processes network traffic at the application layer of the network stack;
inputting the one or more feature values into the machine learning model at the user space to obtain a verdict as output, wherein the verdict indicates malicious or benign network traffic; and
passing the verdict from the user space to the kernel space.

2. The method of claim 1, wherein passing the one or more feature values from kernel space to the user space comprises passing the one or more feature values in zero-copy shared memory, and wherein passing the verdict from the user space to the kernel space comprises passing the verdict in the zero-copy shared memory.

3. The method of claim 1, wherein the one or more feature values are generated based, at least in part, on values extracted from fields of protocol data units of the network traffic.

4. The method of claim 3, wherein the extracted values comprise at least one of destination Internet Protocol addresses, protocol types, and destination ports, HyperText Transfer Protocol cookies, Uniform Resource Locators, hostnames, Server Name Indications, and Domain Name System records.

5. The method of claim 3, wherein the one or more feature values are generated, based, at least in part, on fields extracted from protocol data units of the network traffic.

6. A non-transitory machine-readable medium having program code stored thereon, the program code comprising instructions to:
attach one or more code hooks with a virtual machine executing on the machine-readable medium to a network interface of the machine-readable medium at the data link layer of a network stack;
based on receipt of network traffic at the network interface triggering a first of the one or more code hooks, generate one or more feature values of the network traffic;
communicate the one or more feature values from the kernel space to a user space of the machine-readable medium;
input the one or more feature values into a machine learning model to obtain a verdict of the network traffic as output, wherein the verdict indicates malicious or benign network traffic; and
communicate the verdict from the user space of the machine-readable medium to the virtual machine.

7. The non-transitory machine-readable medium of claim 6, wherein the instructions to communicate the one or more feature values from the kernel space to the user space and the instructions to communicate the verdict from the user space to the kernel space comprise instructions to pass the one or more feature values and the verdict, respectively, in zero-copy shared memory.

8. The non-transitory machine-readable medium of claim 6, wherein the one or more feature values are generated based on values extracted from protocol data unit fields of the network traffic.

9. The non-transitory machine-readable medium of claim 8, wherein the extracted values comprise at least one of destination Internet Protocol addresses, protocol types, and destination ports, HyperText Transfer Protocol cookies, Uniform Resource Locators, hostnames, Server Name Indications, and Domain Name System records.

10. The machine-readable medium of claim 8, wherein the machine learning model comprises at least one of a string-matching model, a random forest model, a neural network model, and a gradient boosting model.

11. The non-transitory machine-readable medium of claim 6, wherein the instructions to attach the one or more code hooks from the kernel space to the network interface comprise instructions to attach the one or more code hooks with eBPF.

12. The non-transitory machine-readable medium of claim 6, further comprising instructions to, based on passing a malicious verdict from the user space to the kernel space, throttle the network traffic at the network interface.

13. An apparatus comprising:
a processor;
a network interface; and
a machine-readable medium, the machine-readable medium having instructions stored thereon that are executable by the processor to cause the apparatus to:
receive network traffic at the network interface, wherein the network traffic comprises network traffic at the data link layer of a network stack implementation for the apparatus;
based on receipt of the network traffic triggering a first of one or more code hooks, process the network traffic to generate one or more feature values of the network traffic;
pass the one or more features value from the data link layer to the application layer of the network stack implementation;
input the one or more feature values into a machine learning model at the application layer of the network stack implementation to obtain a verdict for the network traffic, wherein the verdict indicates whether the network traffic is malicious or benign; and
pass the verdict from the application layer to the data link layer of the network stack implementation.

14. The apparatus of claim 13, wherein the instructions to pass the one or more feature values from the data link layer to the application layer and the instructions to pass the verdict from the application layer to the data link layer of the network stack implementation comprise instructions executable by machine-readable medium to cause the apparatus to pass the one or more feature values and the verdict, respectively, in zero-copy shared memory.

15. The apparatus of claim 13, wherein the one or more feature values are generated based on values extracted from protocol data unit fields of the network traffic.

16. The apparatus of claim 15, wherein the extracted values comprise at least one of destination Internet Protocol addresses, protocol types, and destination ports, HyperText Transfer Protocol cookies, Uniform Resource Locators, hostnames, Server Name Indications, and Domain Name System records.

17. The apparatus of claim 15, wherein the machine learning model comprises at least one of a string-matching model, a random forest model, a neural network model, and a gradient boosting model.

18. The apparatus of claim 13, further comprising instructions executable by the processor to cause the apparatus to attach the one or more code hooks at the network interface with an in-kernel virtual machine with eBPF, wherein the one or more code hooks receive and redirect protocol data units of the network traffic from the network interface.

19. The apparatus of claim 13, wherein the network interface comprises a network interface card.

20. The apparatus of claim 13, further comprising instructions executable by the processor to cause the apparatus to, based on passing a malicious verdict from the application layer to the data link layer of the network stack implementation, throttle the network traffic at the network interface.
